(19) United States
(12) Patent Application Publication
(10) Pub. No.: US 2017/0270157 A1
(43) Pub. Date: Sep. 21, 2017

(54) TCP/IP Network Automation and Orchestration Tools

(71) Applicant: Virtual Network Element, Inc., Beverly, MA (US)

(72) Inventor: Kalidas Porika, Nashua, NH (US)

(73) Assignee: Virtual Network Element, Inc., Beverly, MA (US)

(21) Appl. No.: 15/075,623

(22) Filed: Mar. 21, 2016

(51) Int. Cl. G06F 17/30

(52) U.S. Cl. CPC G06F 17/30392; G06F 17/30595; G06F 17/30876

(57) ABSTRACT

The invention comprises a computer-based method for automatically generating a user interface (“UI”) and an application program interface (“API”) that can be used by TCP/IP network administrators. Embodiments herein send a query to a network device seeking metadata for each of the attributes supported thereon. When an answer is returned, which in some embodiments can be sent to devices supporting a Redfish protocol, the response is used to populate a relational database containing metadata for the device, as well as each attribute supported thereon. This metadata is organized in a hierarchical relational database, which is then used to automatically generate a user interface and an application program interface. The user interface and the application program interface are used to manage the settings on the network device. The user interface and application program interface or created using a proprietary data modeling language that is easy to use because it eliminates the need to code every action. Rather, the code needed for performing network administrative tasks is automatically generated using the metadata received from the network device.

### FIELD

The present invention relates generally to a computer-based application for automatically generating an application program interface (“API”) and user interface (“UI”) that can be used in a TCP/IP network.

### BACKGROUND

It is critical in today's networks for operators to implement integrated expert network management solutions capable of interconnecting elements to consolidate the work process flow of network and subscriber tasks, configuration tasks, and performance and fault management. This is true irrespective of whether the network is an enterprise network providing services to a subset of individuals associated with an enterprise or a wireless network providing services to subscribers.

An intelligent, integrated network management system should be designed to support standard technologies and accommodate network growth and network management system upgrades. Based on open, scalable architectures, an intelligent network management solution should be capable of supporting high message volumes and more network elements as applications and the number of devices within the network grows. An intelligent network management solution should also allow applications to be easily customized and new functionality to be added by network operators, system suppliers, or third parties.

When a network administrator builds or maintains a network, he or she has to custom-code functionality within the elements of the network. For small networks, consisting of a single server, the task of building and maintaining applications on the server is manageable. As the network grows and incorporates cloud components and additional servers, the administration and maintenance tasks become daunting. Even at the enterprise level, network administration can become unwieldy pretty quickly, especially when we take into consideration the fact that many network administrators are responsible for deploying and maintaining networks that are distributed all over the world.

In many enterprise solutions, network infrastructure is often decentralized, which results in network administrators having to deploy nearly identical services across largely identical servers. To address this situation, network administrators often use configuration management tools, for example and without limitation, Puppet, Chef, Ansible, Fabric, and Saltstack. Although these tools simplify automation within a network, they are often challenging to use because they typically require substantial programming skills. In the wireless network arena, some examples of configuration management tools include, without limitation, Cisco Network Assistant, Dorado Software, Netcordia, Solarwinds, EMC Ionix Network Configuration, HP, RANCID, Netomata Config Generator, and the ZipTie package, which Alterpoint has incorporated into its product.

Some of the advantages of having network configuration management tools are: (1) streamlining the processes of maintenance, repair, expansion and upgrading; (2) minimizing configuration errors and downtime; (3) optimizing network security; (4) ensuring changes made to a device or system do not adversely affect other devices or systems; (5) rolling back changes to a previous configuration if results are unsatisfactory; and (6) archiving the details of all network configuration changes.

The easier and more intuitive a network management solution is, the more effective it will ultimately be. Ultimately, the ease of use of any network management tool will depend upon the user interface and the application program interface for the management tool. If the user interface is difficult to use, and if the application program interface is not robust enough, the network management tool will be commensurately less effective.

In addition, network management tools must have the most current metadata related to each network node and the applications running thereon. If a network management tool is not up-to-date, its ability to manage will be significantly compromised. Manually updating an API or a UI to reflect changes that have occurred in network nodes is time consuming and fraught with the possibility for error.

Accordingly, it is desirable to have a computer-based application tool suite comprised of tools that automatically generate an API and a UI, which are easy to use, robust, current, and customizable.

### SUMMARY OF THE INVENTION

The invention comprises a computer-based method for automatically generating a user interface and an application program interface that can be used by network administrators whose job is overseeing and maintaining a TCP/IP network. Presently, the task of overseeing and maintaining a TCP/IP based network requires substantial coding skills and individual attention to each network node, the attributes contained therein, and any changes or inconsistencies that may have been introduced to the network unbeknownst to the network administrator. The embodiments of this invention couple together a query sent to a network device seeking metadata for each of the attributes supported by that network device.

When an answer is returned to that query, which in some embodiments can be sent to devices supporting a Redfish protocol, the data in the query response can be used to populate a relational database containing metadata for the device, also called interchangeably a root device, as well as each attribute supported thereon. This metadata can be organized in a hierarchical relational database, which is then used to automatically generate a user interface and an application program interface. The user interface and the application program interface are used to manage the settings on the network device. The user interface and application program interface are created using a proprietary data modeling language that is easy to use because it eliminates the need to code every action. Rather, the code needed for performing network administrative tasks is automatically generated using the metadata received from the network device in response to the query.

The embodiments of this invention allow network administrators to configure and modify default settings and to create new instances of attributes. Network administrators can use the API to configure their desired service in relation to other services being offered within the network, which solves difficulties heretofore present in network integration. Additionally, the user interface and application program interface of the present invention allow administrators to implement a change in the network, such as altering an existing attribute, adding a new attribute, or customizing an attribute, while still adhering to existing settings. These changes can be made without having to write new code for each change because the user interface presents the administrator with a straightforward, menu-driven set of commands based on up-to-date metadata that can be implemented by virtue of selecting menu options within the UI.

The API, which is integral to the UI, takes these menu-driven selections, couples them to existing code within the API written in a variety of languages, and executes the desires of the network administrator on the back-end. The API is very flexible because it supports numerous popular coding languages such as Raw, cURL, Java, JavaScript, Node.js, Perl, Python, Go, C++, Visual Basic, Groovy, Objective-C, Swift, and evolutions of these languages that may be created in the future. This flexibility obviates the need for the network administrator to be capable of coding in these various languages in order to make changes within the network. Rather, the network administrator expresses his or her desired changes through the user interface, which in turn relies upon the application interface program to exact those changes in the appropriate language for the network being maintained.

In one embodiment, we disclose a computer implemented method for performing network administration in a transmission control protocol/Internet protocol network having at least one device configured to use a RESTful interface semantic, comprising the steps of: (a) sending a metadata document request to a network device; (b) receiving a response to the metadata document request wherein the response includes a root node name, at least one other attribute name, and metadata for the at least one other attribute; (c) storing the root node name, the at least one attribute name, and the metadata for the at least one attribute in a relational database; and (d) retrieving the metadata for the at least one attribute from the relational database in order to automatically generate a user interface and an application program interface based on the metadata for the at least one attribute in the relational database.

In an alternate embodiment, we disclose a computer hardware system comprising a hardware processor having a set of computer coded instructions stored in a memory storage device coupled to the processor and a communication interface wherein the hardware processor, the memory storage device, and the communication interface are configured to initiate or perform the steps of: (a) sending a metadata document request from the communication interface to a network device; (b) receiving a response to the metadata document request from the network device wherein the response includes a root node name, at least one other attribute name, and a metadata for the at least one other attribute; (c) storing the root node name, the at least one attribute name, and the metadata for the at least one attribute in a relational database located in the memory storage device; and (d) retrieving the metadata for the at least one attribute from the relational database using the processor in order to automatically generate a user interface and an application program interface based on the metadata for the at least one attribute in the relational database.

### BRIEF DESCRIPTION OF THE DRAWINGS

FIG. 1 is a simplified block diagram of a system for performing automatic generation of a user interface and an application program interface according to embodiments disclosed herein.

FIG. 2 is screenshot of a portion of a relational database entry for exemplary embodiments disclosed herein.

FIG. 3 is a screenshot of a relational database entry for an exemplary attribute used in embodiments disclosed herein.

FIG. 4 is a flow chart showing steps of a computer-based method for automatically generating a user interface and an application program interface for embodiments disclosed herein.

### DETAILED DESCRIPTION

In modern networks, there are numerous standards that govern the exchange of data among the network nodes. The Internet Engineering Task Force (“IETF”) is a group of volunteers tasked with developing and promoting Internet standards, in particular the standards that comprise the Internet protocol suite (“TCP/IP”). At this time, there are over 7400 IETF standards governing the exchange of network data over the Internet. See generally http://www.ietf.org/download/rfc-index.txt, the entire contents of which are hereby incorporated by reference. Given the shear number of varying standards that may exist on any given device, managing interoperability is a major part of a network manager's job.

One exemplary standard is the Network Configuration Protocol (“NETCONF”), which provides operators and application developers with a standard framework and a set of standard Remote Procedure Call (“RPC”) methods to manipulate the configuration of a network device. NETCONF is usually transported over the SSH protocol, using the ‘netconf’ sub-system (similar to the ‘sftp’ sub-system). In many ways it mimics the native proprietary CLI over SSH interface available in the device. However, NETCONF uses structured schema-driven data, and provides detailed structured error return information, which the CLI cannot provide.

The device configuration data, and the protocol itself, are encoded with the Extensible Markup Language (“XML”) Standard tools, such as XML Path Language (“XPath”), which can be used to provide retrieval of a particular subset of configuration data. All NETCONF messages are encoded in XML within XML Namespaces. The protocol messages usually contain user data in a different namespace than the NETCONF protocol PDUs. NETCONF devices allow configuration data to be locked, edited, saved, and unlocked. In addition, all modifications to the configuration data must be saved across a reboot in non-volatile storage.

The protocol, and sometimes the configuration data, are conceptually partitioned, based on a “capability.” These capabilities, which are interchangeably called attributes herein, are given unique identifiers and advertised by the server when the client starts a NETCONF session. An attribute represents a set of functionalities provided by the device or node. Attributes can be nested or additive. In NETCONF protocol enabled networks, a server must provide a core set of operations. If a client desires additional operations or attributes, it must determine if the server can support these additional attributes/operations.

Within the NETCONF protocol, there is a data modeling language called YANG, which is used to model configuration and state data manipulated by the NETCONF protocol, NETCONF remote procedure calls, and NETCONF notifications. YANG is used to model the operations and content layers of NETCONF. See https://tools.ietf.org/html/rfc6020, the entire contents of which are hereby incorporated by reference. Embodiments disclosed herein use a protocol similar to that disclosed in YANG in order to effectuate a data modeling language for creating a user interface. Similar data modeling languages, aside from YANG could be XML with DTD, and the like.

The Redfish Scalable Platforms Management API (“Redfish”) is a new specification that uses RESTful interface semantics to access data defined in model format to perform out-of-band systems management. It is suitable for a wide range of servers, from stand-alone servers to rack mount and bladed environments, but scales equally well for large scale cloud environments. See generally “Redfish Scalable Platforms Management API Specification,” Distributed Management Task Force, Document Identifier: DSP0266, Date: 2015, Aug. 4, Version: 1.0.0, the entire contents of which are hereby incorporated by reference.

“The Redfish Scalable Platform Management API (‘Redfish’) is a management standard using a data model representation inside of a hypermedia RESTful interface. Because it is based on REST, Redfish is easier to use and implement than many other solutions. Since it is model oriented, it is capable of expressing the relationships between components in modern systems as well as the semantics of the services and components within them. It is also easily extensible. By using a hypermedia approach to REST, Redfish can express a large variety of systems from multiple vendors.” Id.

Redfish utilizes a Java Script Object Notation (“JSON”) payload. “By requiring JSON representation, a wide variety of resources can be created in a denormalized fashion not only to improve scalability, but the payload can be easily interpreted by most programming environments, as well as being relatively intuitive for a human examining the data. The model is exposed in terms of an interoperable Redfish Schema, expressed in an OData Schema representation with translations to a JSON Schema representation, with the payload of the messages being expressed in a JSON following OData JSON conventions. The ability to externally host the Redfish Schema definition of the resources in a machine-readable format allows the meta data to be associated with the data without encumbering Redfish services with the meta data, thus enabling more advanced client scenarios as found in many data center and cloud environments.” Id.

“OData defines a set of common RESTful conventions and markup which, if adopted, provides for interoperability between APIs. Adopting OData conventions for describing Redfish Schema, URL conventions, and naming and structure of common properties in a JSON payload, not only encapsulate best practices for RESTful APIs but further enables Redfish services to be consumed by a growing ecosystem of generic client libraries, applications, and tools. The Redfish model is built for managing systems. All resources are defined in OData Schema representation and translated to JSON Schema representation. OData is an industry standard that encapsulates best practices for RESTful services and provides interoperability across services of different types. JSON is being widely adopted in multiple disciplines and has a large number of tools and programming languages that accelerate development when adopting these approaches.” Id.

JSON payloads include type identifiers, which are defined in, or referenced by, the service metadata. Resource types defined by the Redfish specification are referenced in JSON documents using the full (versioned) namespace name.

When nodes or devices are providing Redfish services, those devices must be amenable to receiving a request for a description of the services they provide. Most typically, the device would receive this type of service inventory request via an API on the device. In response to the request, the device “shall expose a metadata document describing the service at the “/redfish/v1/$metadata” resource. This metadata document describes the resources and collections available at the root, and references additional metadata documents describing the full set of resource types exposed by the service. Services shall not require authentication in order to retrieve the metadata document.” Id.

On a node or device providing Redfish services, there are also property types, which are “specified by the Type attribute. The value of the type attribute may be a primitive type, a structured type, an enumeration type or a collection of primitive, structured or enumeration types. . . . Enumeration types are defined within a namespace using EnumType elements. The Name attribute of the enumeration type specifies the name of the enumeration type. Enumeration types may be reused across different properties of different resource types. EnumType elements contain Member elements that define the members of the enumeration. The Member elements contain a Name attribute that specifies the string value of the member name.” Id.

YANG data hierarchy constructs include defining lists where list entries are identified by keys that distinguish them from each other. Such lists may be defined as either sorted by user or automatically sorted by the system. For user-sorted lists, operations are defined for manipulating the order of the list entries. YANG strikes a balance between high-level data modeling and low-level bits-on-the-wire encoding. The reader of a YANG module can see the high-level view of the data model, while understanding how the data will be encoded in NETCONF operations.

Like NETCONF, YANG targets smooth integration with the device's native management infrastructure. This allows implementations to leverage their existing access control mechanisms to protect or expose elements of the data model. YANG has a set of built-in types, similar to those of many programming languages, but with some differences due to special requirements from the management domain. The following list contains the the YANG built-in types: binary, Boolean, decimal64, empty, enumeration, identityref, instance-identifier, int8, int16, int32, leafref, string, uint8, uint16, uint32, uint64, and union.

In embodiments of the present invention, we disclose an automated computer-based process for creating an API or a UI that is customized upon generation to account for all attributes running on a particular network device. The auto-generated API and UI devices are also scalable to accommodate all network devices within a particular IETF network. Although the embodiments disclosed herein were designed to operate with devices using a Redfish protocol, those of skill in the art will recognize that these embodiments would work equally well with any protocol that uses RESTful interface semantics to access data defined in model format.

The types of networks that can be managed using the API or UI created herein are as varied as any network designer could fathom so long as the networks adhere to IETF standards, either legacy, current, or future.

In some embodiments, we have created a customized data modeling language that works in conjunction with the Redfish protocol to automatically create a UI or an API that network managers can use to manage a device or multiple devices. Network administrators use the UI and API to: (1) configure network elements; (2) modify applications on network elements: (3) modify default settings; (4) create new attributes; (5) integrate or customize integration management tools; (6) roll out changes in a synchronized manner; (7) track any changes made within the network; and (8) preserve the ability to back out of changes made within the network.

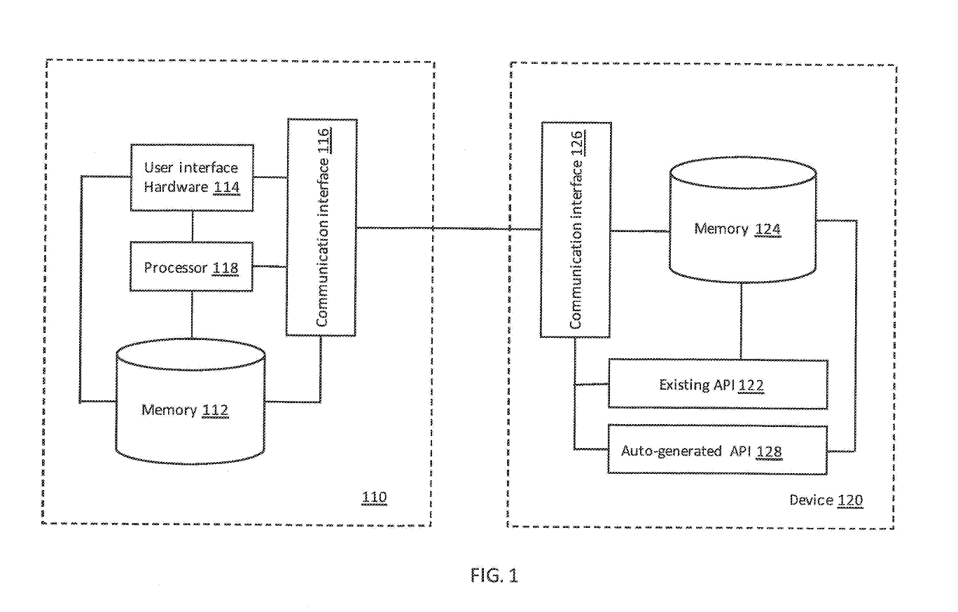

FIG. 1 shows a simplified block diagram of a computer-based system 110 that could be used in embodiments herein disclosed. Specifically, the computer-based system 110 could comprise, among other things, a memory storage device 112, user interface hardware 114, a communication interface 116, and a processor 118. Although not shown, those of skill in the art will recognize that the user interface hardware 114 could be further comprised of a memory storage unit, a display, and/or in input device. As can be seen from FIG. 1, the computer-based system 110 is communicatively coupled to an TCP/IP device 120, which has an existing API 122 integrally associated therewith. The existing API 122 could be, for example, a default API that was part of the factory settings for the TCP/IP device 120.

The existing API 122 is communicatively coupled to the communication interface 116. In addition, the TCP/IP device 120 has a memory storage device 124, among other hardware components. The memory storage device 124 could be internal to the device or it could be external, such as, without limitation, a network memory drive or a cloud based memory storage device. The memory storage device 124 has read and write capabilities and is communicatively coupled to the communication interface 126 on the TCP/IP device.

The communication interfaces 116 and 126 are configured to send and receive data communications in response to queries received from other devices. In an embodiment, the communication interface 116 could send a message to the TCP/IP device 120 seeking information regarding the TCP/IP device's 120 resources, for example its modules and attributes. This request could be received by communication interface 126. In some embodiments, communication interface 126 could be coupled to an existing API 122. In these embodiments, communication interface 126 would retrieve the answers to the request from the existing API 122 and return those answers to communication interface 116. In alternate embodiments, communication interface 126 could obtain answers to the request from a memory storage unit 126 or from an auto-generated API 128.

Once the communication interface 116 receives answers to its request, it sends those answers to a processor 118, which is communicatively coupled to a memory storage device 112. Although FIG. 1 shows the memory storage device 112 as an internal device, those of skill in the art will recognize the memory storage device 112 could be, for example and without limitation, an external memory server or cloud based memory storage.

The processor 118 is configured with computer-based instructions that direct it to create relational database entries corresponding to the answers received by the communication interface 116, e.g., module and attribute information for the TCP/IP device 120. The processor 118 executes these coded instructions to create at least one root corresponding to a module and at least one leaf entry corresponding to an attribute. The root and leaf entries are stored in memory storage device 112.

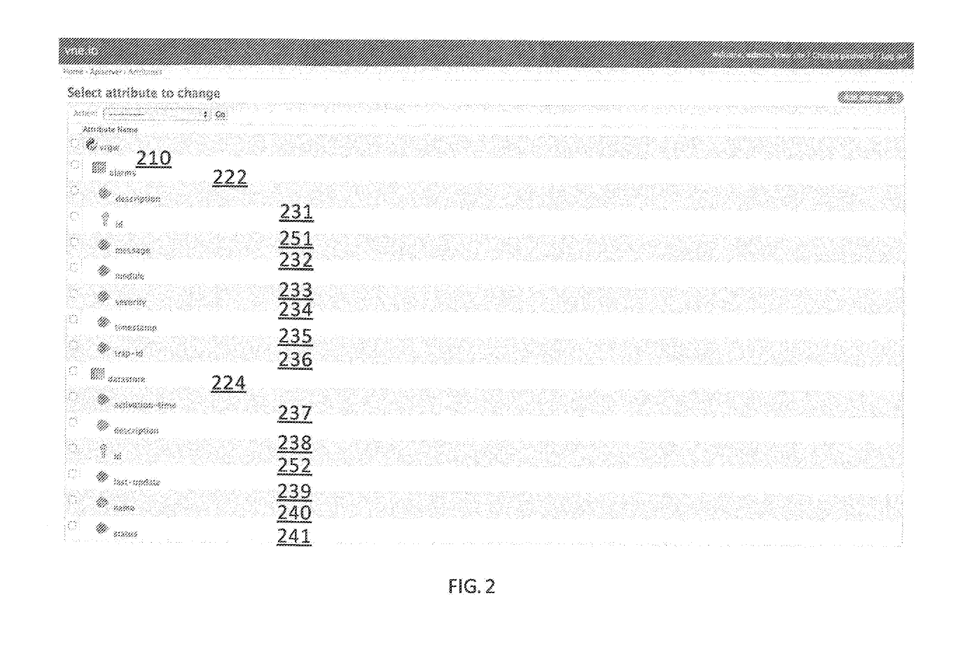

FIG. 2 shows an example of an entry that could be stored in the memory storage device 112. As can be seen in FIG. 2, the root 210, which is the device type, in this embodiment could be a virtual gateway. The virtual gateway is a device that could exist in a TCP/IP network. When the communication interface 116 sent a query to the network device 120 seeking information related to what type of device the network device 120 is as well as its attributes, in this embodiment the device 120 responded by identifying itself as a virtual gateway. As those of skill in the art will recognize, there are myriad device types that could be returned in response to the query. Accordingly, in alternate embodiments, the device type could be, for example and without limitation, a router, a switch, a firewall, a load balancer, a DNS server, a P-GW, an MME, and the like.

In addition, the network device 120 also sent attribute information to the communication interface 116, which in turn relayed that information to the processor 118. From there the processor 118 executed the code corresponding to embodiments herein to create the list of attributes shown in FIG. 2. Specifically, in this embodiment, the virtual gateway root 210 has two attributes, namely alarms 222 and datastore 224. Both alarms 222 and datastore 224 are attribute type table. Those of skill in the art will recognize that additional attribute types could be file, IP Address V4/V6, MAC Address, Netmask, Interface Speed Interface Name and the like.

Each attribute 222 and 224 has at least one leaf associated therewith. The alarms attribute 222 has the following leaves hierarchically placed thereunder: description 231, message 232, module 233, severity 234, time stamp 235, trap-id 236. The datastore attribute 224 has the following leaves hierarchically placed thereunder: activation time 237, description 238, last update 239, name 240, status 241.

In addition, each attribute has stored hierarchically thereunder a key. Specifically, the alarms attribute 222 key is shown as reference numeral 251, whereas the datastore attribute 224 key is shown as reference numeral 252. Those of skill in the art will recognize that one way to generate a key, without limitation is by exchanging the tree structure with a client using an API that returns all of the attributes supported by the device as well as their order. In one embodiment the API could be “get-meta,” which could return a JSON response containing all of the attributes supported by the device as well as their respective order.

Referring to the individual leaves, some of the leaves are read-only, while some are editable. This distinction is shown pictorial in FIG. 2. For example, description 231, message 232, module 233, severity 234, time stamp 235, trap id 236, activation time 237, last update 239, and status 241 are read only. This is depicted as a “X” mark through the leaf symbol in FIG. 2. In contrast, description 238 and name 240 are editable as depicted by an unadorned leaf in FIG. 2. When the computer-bases system, or client, 110 and the TCP/IP device, or server, 120 exchange metadata, the TCP/IP device 120 gives the tree structure and the type of data, i.e., read, read-write, etc. to the computer-based system, or client 110.

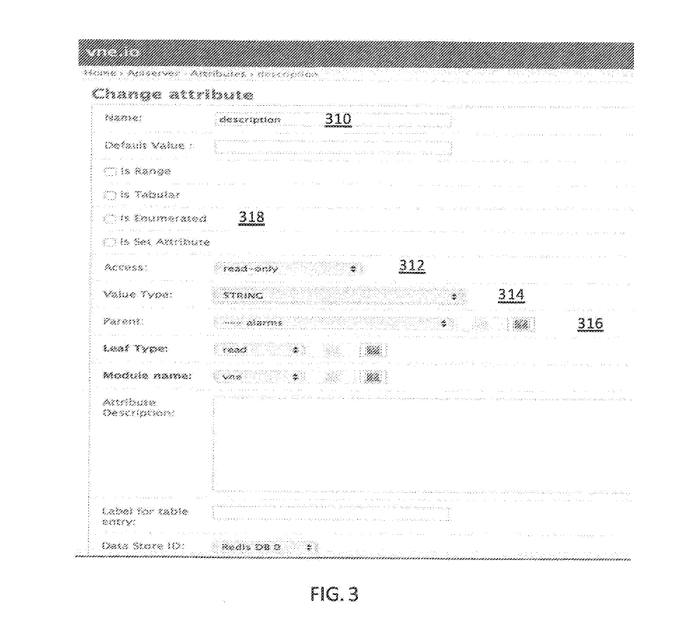

Each of the leaves that would be stored in the memory storage device 112 has a corresponding entry within the relational database that includes additional information related to that leaf. By way of example, FIG. 3 shows an entry for the description leaf 231 under the alarms 222 attribute. FIG. 3 identifies this data entry as corresponding to the description leaf 231 in the name field 310. In this instance, the description leaf 231 is read-only, as can be seen in the Access field 312. The value type 314 for the description leaf 231 in this instance is STRING. The entry also shows the parental relationship 316 for the description leaf 231.

In this embodiment, the value type 314 was STRING. In additional embodiments, the value type could be STRING, OBJID, INTEGER, NULLOBJ, IPADDRESS, NETWROK ADDRESS, COUNTER32, GAUGE, UNISGNED32, UNINTEGER32, TIMETICKS, OPAQUE, COUNTER64, DOUBLE, IPv6, EMAIL, URL, URI, EPOCH, DATETIME, DATE, BOOLEAN, FILE, uint8, uint32, and Reference. As those skilled in the art will recognize, the embodiments herein support attributes that are supported in SNMP and other network management attributes. In addition, embodiments herein allow users to create a custom value type 314 for an attribute 222, 224. In addition, users can create custom attributes 222, 224.

In alternate embodiments, the invention supports various property types. In the Redfish protocol, there are varying property types that can be defined. The standard allows for a type of a property to be specified by the type attribute. The value of the type attribute may be a primitive type, a structured type, an enumeration type or a collection of primitive, structured or enumeration types. As can be seen in FIG. 3, the embodiments disclosed herein support enumeration types 318, as well as primitive and structured types.

Those of skill in the art are aware that enumeration types are defined within a namespace using EnumType elements. The Name attribute of the enumeration type specifies the name of the enumeration type. Enumeration types may be reused across different properties of different resource types. EnumType elements contain Member elements that define the members of the enumeration. The Member elements contain a Name attribute that specifies the string value of the member name. See generally Redfish Protocol supra.

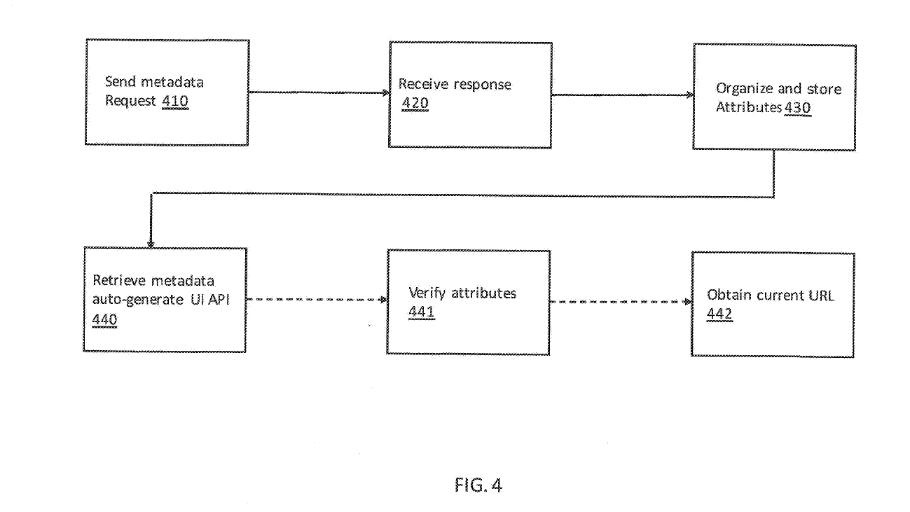

Once the root 210 and attribute 222, 224 information, including the metadata relevant to each of the attributes 222, 224, has been accurately obtained and stored in an entry in a relational database, methods disclosed herein for automatically creating a user interface and an application program interface can be executed. FIG. 4 shows the steps of a computer-implemented method for automatically generating a user interface or an application program interface that can be used in a TCP/IP network.

As can be seen in FIG. 4, the first step of a method disclosed herein could be to obtain information about the root 210 and its attributes 222, 224. As was stated earlier, we discuss a single root 210 and two attributes attributes 222, 224 for illustrative purposes only. There could be in alternate embodiments having a plurality of roots 210 and myriad attributes 222, 224, each having metadata associated therewith. Accordingly, FIG. 4 shows the steps of sending 410 a request to receive metadata from a root and receiving 420 a response to the send 410 request.

In an embodiment that could be used in a Redfish compliant network, the root attribute (module) could be used for exploration of the API, as described in the Redfish specification. In this embodiment, the root module could return URLs to other attributes. In this embodiment, attributes can be of varying types, including without limitation: (1) root, which could be an array, containing URLs to all of the other attributes from the selected configuration; (2) leaf, which could return a value for a single attribute; (3) folder, which could return the values for all of the contained attributes; (4) deep-nesting folder, which could return URLs to the attributes contained therein; (5) table, which could be an array, containing all of the attributes; or (6) record, which could contain values for all of the attributes that are returned, irrespective of folder nesting. In this embodiment, tables are generally not nested; and table records can be created and deleted.

Once the root 210 and attribute 222, 224 metadata are received, they are organized and stored 430, using custom made code, into a relational database. In embodiments, the root 210 and attribute 222, 224 metadata are organized and stored 430 in a tree structure within the relational database similar to what is depicted in FIG. 2. FIG. 3 depicts an example of the type of metadata that could be received 420, organized and stored 430 in the relational database.

The final step shown in FIG. 4 involves retrieving 440 the metadata stored in the relational database in order to automatically generate a user interface and an application program interface. In terns of automatically generating the API and UI, embodiments herein can for example and without limitation review all of the information received 420 in response to the metadata request sent to a single root 210 or multiple device roots.

In our implementation, we call the automatic generation code for generating an API and a UI the nerd protocol. In terms of automatically generating 440, the application program, FIG. 4 shows the steps involved therein. Specifically, the code underlying these embodiments could then verify 441 that all attributes 222, 224 that were returned in the response 420 message are in fact supported by the root 210 node. This could be done, for example, by sending a general request of the structure HEAD/HTTP Method Protocol http:///ProtocolHostvne.io:9090/HostUriTemplate/nerd/api_version/config_version/root_module.

Next, the automatic API generator could obtain 442 current URLs for all of the attributes 222, 224 present at the root 210. By way of example, this could be accomplished via a general GET/HTTP Method Protocol http:///ProtocolHostvne.io:9090/HostUriTemplate/nerd/api_version/config_version/root_module command. In some embodiments, these two steps will be automatically executed. In other embodiments, they could be executed only after a user has entered his/her desire to execute these steps via the automatically generated user interface.

The automatically generated user interface works cooperatively with the application program interface to present the user with an easy to read, drop-down, menu style UI. And while the UI may appear to be straightforward and easy to use, on the back-end via the integration with the auto-generated API, the UI and the API together become robust programming tools for network administrators.

If, for example, a network administrator wished to read or update leaf attributes, he or she could make that request via the UI. For leaf attributes 222, 224 the automatic API generator could read and update leaf attributes as necessary. For reading, a general command could be of the form GET/HTTP Method Protocol http:///ProtocolHostvne.io:9090/HostUriTemplate/nerd/api_version/config_version/root_module/folder/leaf. For updating, a general command such as PUT/HTTP Method Protocol http:///ProtocolHostvne.io:9090/HostUriTemplate/nerd/api_version/config_version/root_module/folder/leaf.

In this embodiment, the general request to read or update a leaf attribute could be accomplished in multiple languages to coincide with the programming language native to the network, or root 210, device. By way of example, and without limitation, the API is capable of translating a user request entered into the auto-generated UI into a command in any of the following languages: Raw, cURL, Java, JavaScript, Node.js, Perl, Python, Go, C++, Visual Basic, Groovy, Objective-C, Swift, and evolutions of these languages that may be created in the future.

For a folder attribute, the UI and API of these embodiments allow reading and updating of folder attributes, which by their very nature have multiple attributes therein. A general command for reading a folder attribute could be of the form GET/HTTP Method Protocol http:///ProtocolHostvne.io:9090/HostUriTemplate/nerd/api_version/config_version/root_module/folder. And a general command for updating a folder attribute could be of the form PUT/HTTP Method Protocol http:///ProtocolHostvne.io:9090/HostUriTemplate/nerd/api_version/config_version/root_module/folder.

In terms of folder attributes with deep nesting, structurally, they are the same as simple folder attributes with one difference—they contain at least one folder or table attribute. Folder attributes return the URLs of the attributes they contain and cannot be updated directly. In our auto-generated API, we allow a user, via the auto-generated UI to retrieve all virtual machine generated URLs. This can be accomplished with a general command such as the following: GET/HTTP Method Protocol http:///ProtocolHostvne.io:9090/HostUriTemplate/nerd/api_version/config_version/root_module/folder_nested

In terms of Table attributes, they represent a collection of record attribute, which are themselves similar to folders. Table attributes return all of the record attributes they contain and they can be updated by creating new record attributes therewithin. We allow users through the UI to read all table attributes via a general command such as GET/HTTP Method Protocol http:///ProtocolHostvne.io:9090/HostUriTemplate/nerd/api_version/config_version/root_module/table. Users can also create new table record attributes through the UI. On the back-end, this can be done via a general command such as POST/HTTP Method Protocol http:///ProtocolHost vne.io:9090/HostUriTemplate/nerd/api_version/config_version/root_module/table.

Record attributes are attributes that represent a collection of attributes and are similar to folder attributes, with the only difference being that record attributes are part of a table. Record attributes return all the attribute values they contain. They can be updated the same way as folder attributes; and they can be deleted.

For Record attributes, our UI and API facilitate the following operations: (1) read all attributes contained in the record attribute; (2) update existing record attribute; and (3) delete existing record attribute. These operations can be accomplished via the following general commands, respectively: (1) GET/HTTP Method Protocol http:///ProtocolHostvne.io:9090/HostUriTemplate/nerd/api_version/config_version/root_module/table/id; (2) PUT/HTTP Method Protocol http:///ProtocolHostvne.io:9090/HostUriTemplate/nerd/api_version/config_version/root_module/table/id; and (3) DELETE/HTTP Method Protocol http:///ProtocolHostvne.io:9090/HostUriTemplate/nerd/api_version/config_version/root_module/table/id.

As stated above, each of these general commands could be carried out in any of the software programs listed above, namely Raw, cURL, Java, JavaScript, Node.js, Perl, Python, Go, C++, Visual Basic, Groovy, Objective-C, Swift, and evolutions of these languages that may be created in the future.

In embodiments disclosed herein, we provide a secure API that requires authentication and/or authorization. Once a user authenticates using the login route, every subsequent attribute request can include the authorization header with the token received from the login response. In some embodiments, an authentication key could be sent from the relational database stored in the memory storage device 112.

In alternate embodiments, the API can be configured so that it is compatible with other configuration management systems. As those of skill in the art know, an API allows one piece of software to talk to another piece of software. Given that the auto-generated API disclosed herein supports Raw, cURL, Java, JavaScript, Node.js, Perl, Python, Go, C++, Visual Basic, Groovy, Objective-C, Swift, and evolutions of these languages that may be created in the future, any API that is capable of communicating in any of these languages should be able to interact with the auto-generated API disclosed herein.

Those of skill in the art will recognize throughout this specification that when like terms are used to describe features and functionalities of various portions of a particular embodiment, those same features and functionalities could be present in additional embodiments having aspects with like terms.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context.

The invention includes embodiments in which exactly one member of the group is present in, employed in, or otherwise relevant to a given product or process. The invention also includes embodiments in which more than one or the entire group of members is present in, employed in or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise.

Where elements are presented as lists, (e.g., in Markush group or similar format) it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The entire contents of all of the references (including literature references, issued patents and published patent applications and websites) cited throughout this application are hereby expressly incorporated by reference.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way which enables a clear and concise specification to be written, but it is intended and will be appreciated, that embodiments may be variously combined or separated without departing from the invention. It is intended that the present invention be limited only to the extent required by the appended claims and the applicable rules of law.

What is claimed is:

1. A computer implemented method for performing network administration in a transmission control protocol/Internet protocol network having at least one device configured to use a RESTful interface semantic, comprising the steps of:
a. sending a metadata document request to a network device;
b. receiving a response to the metadata document request wherein the response includes a root node name, at least one other attribute name, and metadata for the at least one other attribute;
c. storing the root node name, the at least one attribute name, and the metadata for the at least one attribute in a relational database; and
d. retrieving the metadata for the at least one attribute from the relational database in order to automatically generate a user interface and an application program interface based on the metadata for the at least one attribute in the relational database.

2. The computer implemented method for performing network administration in a transmission control protocol/Internet protocol network of claim 1 further comprising the step of communicatively coupling the user interface and the application program interface to the network device.

3. The computer-implemented method for performing network administration in a transmission control protocol/Internet protocol network of claim 1 further comprising the steps of:
a. verifying that the at least one attribute is supported by the root node; and
b. obtaining a current a uniform resource locator for the at least one attribute.

4. The computer-implemented method for performing network administration in a transmission control protocol/Internet protocol network of claim 1 wherein the user interface is generated using a data modeling programming language.

5. The computer-implemented method for performing network administration in a transmission control protocol/Internet protocol network of claim 1 further comprising exchanging messages within the network using a JavaScript Object Notation data format.

6. The computer-implemented method for performing network administration in a transmission control protocol/Internet protocol network of claim 1 further comprising sending an authentication key from the relational database to the automatically generated application user interface.

7. The computer-implemented method for performing network administration in a transmission control protocol/Internet protocol network of claim 1 wherein an attribute type of the at least one attribute is a root, a leaf, a folder, a nested folder, a table, or a record.

8. The computer-implemented method for performing network administration in a transmission control protocol/Internet protocol network of claim 1 wherein the metadata for the at least one attribute is a primitive type, a structured type, or an enumeration type.

9. The computer-implemented method for performing network administration in a transmission control protocol/Internet protocol network of claim 1 wherein the metadata for the at least one attribute is STRING, OBJID, INTEGER, NULLOBJ, IPADDRESS, NETWROK ADDRESS, COUNTER32, GAUGE, UNISGNED32, UNINTEGER32, TIMETICKS, OPAQUE, COUNTER64, DOUBLE, IPv6, EMAIL, URL, URI, EPOCH, DATETIME, DATE, BOOLEAN, FILE, uint8, uint32, Reference, or custom.

10. A computer hardware system comprising a hardware processor having a set of computer coded instructions stored in a memory storage device coupled to the processor and a communication interface wherein the hardware processor, the memory storage device, and the communication interface are configured to initiate or perform the steps of:
a. sending a metadata document request from the communication interface to a network device;
b. receiving a response to the metadata document request from the network device wherein the response includes a root node name, at least one other attribute name, and a metadata for the at least one other attribute;
c. storing the root node name, the at least one attribute name, and the metadata for the at least one attribute in a relational database located in the memory storage device; and
d. retrieving the metadata for the at least one attribute from the relational database using the processor in order to automatically generate a user interface and an application program interface based on the metadata for the at least one attribute in the relational database.

11. The computer hardware system of claim 10 wherein the hardware processor having a set of computer coded instructions stored in the memory storage device coupled to the processor and the communication interface wherein the hardware processor, the memory storage device, and the communication interface are configured to initiate or perform the step of communicatively coupling the user interface and the application program interface to the network device.

12. The computer hardware system of claim 10 wherein the hardware processor having a set of computer coded instructions stored in the memory storage device coupled to the processor and the communication interface wherein the hardware processor, the memory storage device, and the communication interface are configured to initiate or perform the steps of:
a. verifying that the at least one attribute is supported by the root node; and
b. obtaining a current a uniform resource locator for the at least one attribute.

13. The computer hardware system of claim 10 wherein the user interface is generated using a data modeling programming language.

14. The computer hardware system of claim 10 wherein the hardware processor having a set of computer coded instructions stored in the memory storage device coupled to the processor and the communication interface wherein the hardware processor, the memory storage device, and the communication interface are configured to exchange messages within the network using a JavaScript Object Notation format.

15. The computer hardware system of claim 10 wherein the hardware processor having a set of computer coded instructions stored in the memory storage device coupled to the processor and the communication interface wherein the hardware processor, the memory storage device, and the communication interface are configured to initiate or perform the step of sending an authentication key from the relational database to the automatically generated application user interface.

16. The computer hardware system of claim 10 wherein the hardware processor having a set of computer coded instructions stored in the memory storage device coupled to the processor and the communication interface wherein the hardware processor, the memory storage device, and the communication interface are configured to initiate or perform the step of sending an authentication key from the relational database to the automatically generated user interface.

17. The computer hardware system of claim 10 wherein an attribute type of the at least one attribute is a root, a leaf, a folder, a nested folder, a table, or a record.

18. The computer hardware system of claim 10 wherein the metadata for the at least one attribute is a primitive type, a structured type, or an enumeration type.

19. The computer hardware system of claim 10 wherein the metadata for the at least one attribute is STRING, OBJID, INTEGER, NULLOBJ, IPADDRESS, NETWROK ADDRESS, COUNTER32, GAUGE, UNISGNED32, UNINTEGER32, TIMETICKS, OPAQUE, COUNTER64, DOUBLE, IPv6, EMAIL, URL, URI, EPOCH, DATETIME, DATE, BOOLEAN, FILE, uint8, uint32, Reference, or custom.
